(19) United States
(12) Patent Application Publication
(10) Pub. No.: US 2018/0323563 A1
(43) Pub. Date: Nov. 8, 2018

(54) USB Type-C Plug and Cable

(71) Applicant: Huawei Technologies Co., Ltd., Shenzhen (CN)

(72) Inventor: Zhongjie Xu, Beijing (CN)

(21) Appl. No.: 15/772,363

(22) PCT Filed: Oct. 30, 2015
(86) PCT No.: PCT/CN2015/093376

§ 371 Date: Apr. 30, 2018

(51) Int. Cl. H01R 29/00; H01R 13/70; H01R 13/66; H01R 24/62

(52) U.S. Cl. CPC H01R 29/00; H01R 13/70; H01R 2107/00; H01R 24/62; H01R 13/6616

(57) ABSTRACT

A universal serial bus (USB) Type-C plug and a USB Type-C cable, where the USB Type-C plug includes a dual-role port (DRP) and a role control switch, where the DRP is configured to connect to a USB device, and the role control switch is connected to the DRP and configured to control a port attribute of the DRP, and the port attribute includes a slave device port or Up Facing Port (UFP), a host device port or Down Facing Port (DFP), or no role control. A role control switch controls a port attribute of a DRP such that a USB Type-C cable that includes a USB Type-C plug can control host/slave attributes of devices on both ends of the cable. A user can connect different devices more clearly and explicitly, thereby avoiding a scenario in which a power supply orientation is incorrect.

### CROSS-REFERENCE TO RELATED APPLICATION

This application is a U.S. National Stage of International Patent Application No. PCT/CN2015/093376 filed on Oct. 30, 2015, which is hereby incorporated by reference in its entirety.

### TECHNICAL FIELD

The present disclosure relates to the computer field, and in particular, to a universal serial bus (USB) Type-C plug and cable.

### BACKGROUND

USB Type-C is a new USB port standard published by USB Implementers Forum (USB-IF), and supports a reversible USB Type-C plug, providing better user experience for users.

In USB Type-C specifications, both ends of a USB Type-C cable have a USB Type-C plug. A device into which they are inserted may have three “roles”, a slave device port (or Up Facing Port (UFP)), a host device port (or Down Facing Port (DFP)), and a dual-role port (DRP).

When two DRPs of a USB Type-C cable are respectively connected to a device A and a device B, the device A and the device B randomly determine a host/slave relationship and establish a connection. Consequently, the following cases exist. After the connection is established, the device A serves as a host device, and the device B serves as a slave device, or after the connection is established, the device A serves as a slave device, and the device B serves as a host device. The two possibilities cause a connection result to be random and uncontrollable and cause some potential problems about a logical power supply/utilization error.

### SUMMARY

Embodiments of the present disclosure provide a USB Type-C plug and cable in order to control roles of both ends of the USB Type-C cable such that a user can connect different devices more clearly and explicitly, avoiding a scenario in which a power supply orientation is incorrect.

A first aspect provides a USB Type-C plug, including a DRP and a role control switch, where the DRP is configured to connect to a USB device, and the role control switch is connected to the DRP and configured to control a port attribute of the DRP, and the port attribute includes a UFP, a DFP, or no role control.

With reference to the first aspect, in a first possible implementation, a specific implementation is as follows. The role control switch is configured to connect a channel configuration (CC) pin of the DRP and a power cable of the USB Type-C plug using a first resistor, connect a CC pin of the DRP and a ground cable of the USB Type-C plug using a second resistor, or connect a CC pin of the DRP and a CC wire of a cable on which the USB Type-C plug is disposed.

With reference to the first aspect or the first possible implementation of the first aspect, in a second possible implementation, a specific implementation is as follows. The role control switch is a mechanical dual in-line package switch or an electrical switch.

A second aspect provides a USB Type-C cable, including the USB Type-C plug according to any one of the first aspect, the first possible implementation of the first aspect, or the second possible implementation of the first aspect.

With reference to the second aspect, in a first possible implementation, a specific implementation is as follows. Ports on both ends of the USB Type-C cable are the USB Type-C plugs.

With reference to the second aspect, in a second possible implementation, a specific implementation is as follows. A port on one end of the USB Type-C cable is the USB Type-C plug, and a port on the other end is a USB Type-A plug, a USB Type-B plug, a USB Mini-B plug, or a USB Type-C plug that does not have a role control switch.

With reference to the second aspect, in a third possible implementation, a specific implementation is as follows. A port on one end of the USB Type-C cable is the USB Type-C plug, and the other end is directly connected to a device.

According to the foregoing technical solutions and the USB Type-C plug and cable in the embodiments of the present disclosure, a role control switch controls a port attribute of a DRP such that the USB Type-C cable that includes the USB Type-C plug can control host/slave attributes of devices on both ends of the cable. In this way, a user can connect different devices more clearly and explicitly, thereby avoiding a scenario in which a power supply orientation is incorrect.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic structural diagram of a USB Type-C plug according to an embodiment of the present disclosure;

FIG. 2 is a schematic circuit diagram of a USB Type-C plug according to an embodiment of the present disclosure;

FIG. 3 is another schematic circuit diagram of a USB Type-C plug according to an embodiment of the present disclosure; and

FIG. 4 is a schematic structural diagram of a USB Type-C cable according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

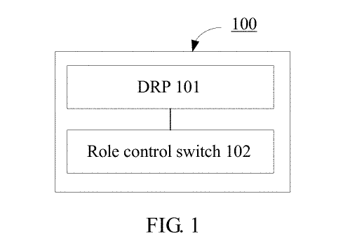

FIG. 1 is a schematic structural diagram of a USB Type-C plug 100 according to an embodiment of the present disclosure. As shown in FIG. 1, the USB Type-C plug 100 may include a DRP 101 and a role control switch 102.

The DRP 101 is configured to connect to a USB device.

The role control switch 102 is connected to the DRP 101 and configured to control a port attribute of the DRP 101.

The port attribute includes a UFP, a DFP, or no role control.

It should be understood that the DRP 101 is a dual-role device and complies with a DRP port stipulation in a USB Type-C specification.

It should be understood that when the role control switch 102 controls the port attribute of the DRP 101 to be UFP, a device connected to the DRP 101 serves as a slave device, when the role control switch 102 controls the port attribute of the DRP 101 to be DFP, a device connected to the DRP 101 serves as a host device, when the role control switch 102 controls the port attribute of the DRP 101 to be no role control, a device connected to the DRP 101 may exist as a host device or may exist as a slave device. A function of the DRP 101 is the same as that of a DRP port in a USB Type-C plug in other approaches.

In this embodiment of the present disclosure, a role control switch controls a port attribute of a DRP such that a USB Type-C cable that includes a USB Type-C plug can control host/slave attributes of devices on both ends of the cable. In this way, a user can connect different devices more clearly and explicitly, thereby avoiding a scenario in which a power supply orientation is incorrect.

Further, the role control switch 102 is configured to connect a CC pin of the DRP 101 and a power cable of the USB Type-C plug using a first resistor, or connect a CC pin of the DRP 101 and a ground cable of the USB Type-C plug using a second resistor, or connect a CC pin of the DRP 101 and a CC wire of a cable on which the USB Type-C plug is disposed.

When the role control switch 102 connects the CC pin of the DRP 101 and the power cable of the USB Type-C plug using the first resistor, the port attribute of the DRP 101 is UFP.

When the role control switch 102 connects the CC pin of the DRP 101 and the ground cable of the USB Type-C plug using the second resistor, the port attribute of the DRP 101 is DFP.

When the role control switch 102 connects the CC pin of the DRP 101 and the CC wire of the cable on which the USB Type-C plug is disposed, the port attribute of the DRP 101 is no role control. That is, the port attribute of the DRP 101 is still DRP.

In specific application, the role control switch 102 may be a mechanical dual in-line package switch or an electrical switch.

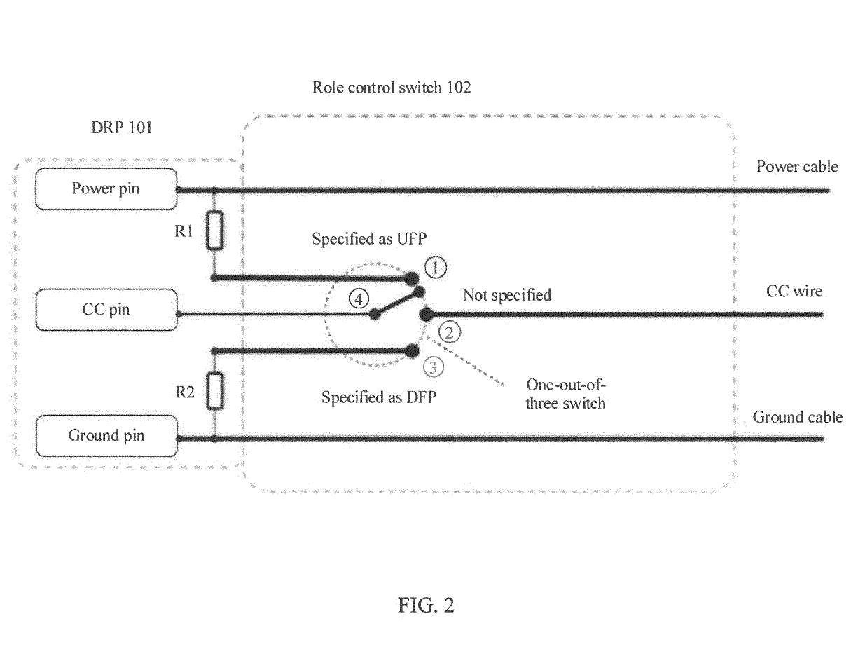

FIG. 2 is a schematic circuit diagram of a USB Type-C plug according to an embodiment of the present disclosure. As shown in FIG. 2, in a dashed block on the right is a role control switch 102, which is an electronic switch. A power pin, a CC pin, and a ground pin shown in FIG. 2 are a power pin, a CC pin, and a ground pin of a DRP 101, respectively.

The power pin is connected to a power cable, the CC pin is connected to an input terminal (\textcircled{4} in FIG. 2) of a one-out-of-three switch, and the ground pin is connected to a ground cable.

An output terminal 1 (\textcircled{1} in FIG. 2) of the one-out-of-three switch is connected to one end of a first resistor (R1 in FIG. 2), and the other end of the first resistor (R1 in FIG. 2) is connected to the power cable.

An output terminal 2 (\textcircled{2} in FIG. 2) of the one-out-of-three switch is connected to a CC wire.

An output terminal 3 (\textcircled{3} in FIG. 2) of the one-out-of-three switch is connected to one end of a second resistor (R2 in FIG. 2), and the other end of the second resistor (R2 in FIG. 2) is connected to the ground cable.

When the one-out-of-three switch controls the CC pin and connects to the power cable using the first resistor (R1 in FIG. 2) (that is, \textcircled{4} in FIG. 2 connects to \textcircled{1}), a port attribute of the DRP 101 is specified as UFP.

When the one-out-of-three switch controls the CC pin and connects to the ground cable using the second resistor (R2 in FIG. 2) (that is, \textcircled{4} in FIG. 2 connects to \textcircled{3}), a port attribute of the DRP 101 is specified as DFP.

When the one-out-of-three switch controls the CC pin and connects to the CC wire (that is, \textcircled{4} in FIG. 2 connects to \textcircled{2} ), a port attribute of the DRP 101 is not specified. That is, the DRP 101 is still a DRP.

Certainly, it should be understood that if a terminal connected to the CC pin is referred to as an output terminal of the one-out-of-three switch, other three terminals are referred to as input terminals of the one-out-of-three switch.

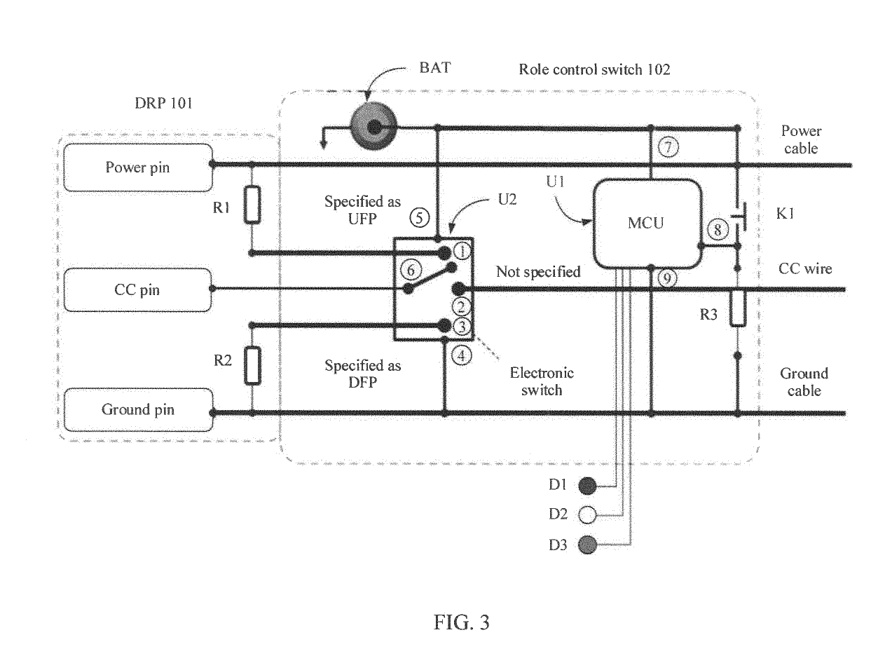

FIG. 3 is a schematic circuit diagram of a USB Type-C plug according to an embodiment of the present disclosure. As shown in FIG. 3, in a dashed block on the right is a role control switch 102 (a one-out-of-three switch), which is an electrical switch and may include a U1, a U2, and a K1. The U2 is an electronic switch, the U1 is a micro control unit (MCU), and the K1 is a key. A power pin, a CC pin, and a ground pin shown in FIG. 3 are a power pin, a CC pin, and a ground pin of a DRP 101, respectively. The U2 is an electronic switch and configured to determine, according to an input signal of a control input terminal (\textcircled{4} in FIG. 3), one output terminal that is of output terminals 1, 2, and 3 (\textcircled{1}, \textcircled{2}, and \textcircled{3} in FIG. 3) and to which a data input terminal (\textcircled{6} in FIG. 3) is to be connected. The U1 is a programmed MCU and configured to output a control signal to the control input terminal (\textcircled{4} in FIG. 3). The K1 is a key and configured to control output of a control signal from the U1 such that an output terminal connected to the data input terminal (\textcircled{6} in FIG. 3) of the U2 switches between the output terminals 1, 2, and 3 (\textcircled{1}, \textcircled{2}, and \textcircled{3} in FIG. 3). The power pin is connected to a power cable, the CC pin is connected to the data input terminal (\textcircled{6} in FIG. 3) of the U2, and the ground pin is connected to a ground cable.

The output terminal 1 (\textcircled{1} in FIG. 3) of the U2 is connected to one end of a first resistor (R1 in FIG. 3), and the other end of the first resistor (R1 in FIG. 3) is connected to the power cable.

The output terminal 2 (\textcircled{2} in FIG. 3) of the U2 is connected to a CC wire.

The output terminal 3 (\textcircled{3} in FIG. 3) of the U2 is connected to one end of a second resistor (R2 in FIG. 3), and the other end of the second resistor (R2 in FIG. 3) is connected to the ground cable.

An output terminal (\textcircled{9} in FIG. 3) of the U1 is connected to the control input terminal (\textcircled{4} in FIG. 3) of the U2, and a power supply terminal (\textcircled{7} in FIG. 3) is connected to a button battery (BAT) and powered by the BAT.

One end of the key K1 is connected to the BAT, and the other end is connected to a control input terminal (\textcircled{8} in FIG. 3) of the U1 and one end of a third resistor (R3). The other end of the third resistor (R3) is connected to the ground cable. The key K1 controls output of the U1, to produce a type of output signal at each connection, and controls the U1 to switch between three types of output signals. The key K1 controls output of the U1 such that the U1 can control the U2 to select the output terminal 1, 2, or 3 as an output terminal of the U2.

D1, D2, and D3 are three light emitting diodes (LED) indicators and play an indication role. D1, D2, and D3 are indicators and configured to indicate a current output signal of the U1, or configured to indicate an output terminal currently connected to the U2. For example, if the D1 indicator is on and D2 and D3 are off, it indicates that an output terminal currently connected to the U2 is the output terminal 1 (\textcircled{1} in FIG. 3), and the data input terminal (\textcircled{6} in FIG. 3) of the U2 is connected to the output terminal 1 (\textcircled{1} in FIG. 3) of the U2, if the D2 indicator is on and D1 and D3 are off, it indicates that an output terminal currently connected to the U2 is the output terminal 2 (\textcircled{2} in FIG. 3), and the data input terminal (\textcircled{6} in FIG. 3) of the U2 is connected to the output terminal 2 (\textcircled{2} in FIG. 3) of the U2, if the D3 indicator is on and D1 and D2 are off, it indicates that an output terminal currently connected to the U2 is the output terminal 3 (\textcircled{3} in FIG. 3), and the data input terminal (\textcircled{6} in FIG. 3) of the U2 is connected to the output terminal 3 (\textcircled{3} in FIG. 3) of the U2, and so on.

When the key K1 is pressed once, the U1 controls the U2 to circularly switch once between three states UFP, not specified, and DFP.

It should be understood that using a mechanical dual in-line package switch or an electrical switch (an electronic switch that includes a key, an MCU, an electronic switch, and an LED indicator) are merely two specific embodiments illustrated in the present disclosure. In actual application, another embodiment in which an electronic switch, a mechanical switch, or a mechanical-electronic switch is used may exist. For example, a mechanical button is replaced with a capacitive touch key, and an LED is replaced with a liquid crystal display (LCD) or organic LED (OLED) display. Details are not described herein.

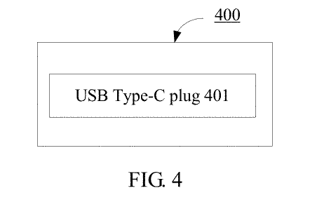

FIG. 4 is a schematic structural diagram of a USB Type-C cable 400 according to an embodiment of the present disclosure. As shown in FIG. 4, the USB Type-C cable 400 may include a USB Type-C plug 401, and the USB Type-C plug 401 is the USB Type-C plug in the embodiment shown in FIG. 1.

In this embodiment of the present disclosure, the USB Type-C cable 400 uses the USB Type-C plug 401 that includes a role control switch, and can control host/slave attributes of devices on both ends of the cable. In this way, a user can connect different devices more clearly and explicitly, thereby avoiding a scenario in which a power supply orientation is incorrect.

Optionally, in an embodiment, ports on both ends of the USB Type-C cable 400 are USB Type-C plugs 100 in the embodiment shown in FIG. 1.

Optionally, in another embodiment, a port on one end of the USB Type-C cable 400 is the USB Type-C plug 100 in the embodiment shown in FIG. 1, and a port on the other end is a USB Type-A plug, a USB Type-B plug, a USB Mini-B plug, or a USB Type-C plug that does not have a role control switch.

Optionally, in an embodiment, a port on one end of the USB Type-C cable 400 is the USB Type-C plug 100 in the embodiment shown in FIG. 1, and the other end is directly connected to a device.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

A person of ordinary skill in the art may be aware that, the units and algorithm steps in the examples described with reference to the embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the other approaches, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1-7. (canceled)

8. A universal serial bus (USB) Type-C plug, comprising:
a dual-role port (DRP) configured to couple to a USB device; and
a role control switch coupled to the DRP and configured to control a port attribute of the DRP, the port attribute comprising a slave device port or up facing port (UFP), a host device port or down facing port (DFP), or no role control.

9. The USB Type-C plug of claim 8, wherein the role control switch is further configured to:
couple a configuration channel (CC) pin of the DRP and a power cable of the USB Type-C plug using a first resistor;
couple the CC pin of the DRP and a ground cable of the USB Type-C plug using a second resistor; or
couple the CC pin of the DRP and a CC wire of a cable on which the USB Type-C plug is disposed.

10. The USB Type-C plug according to claim 9, wherein the role control switch comprises a mechanical dual in-line package switch.

11. The TJSB Type-C plug according to claim 9, wherein the role control switch comprises an electrical switch.

12. A universal serial bus (USB) Type-C cable, comprising a USB Type-C plug comprising:
a dual-role port (DRP) configured to couple to a USB device; and
a role control switch coupled to the DRP and configured to control a port attribute of the DRP, the port attribute comprising a slave device port or up facing port (UFP), a host device port or down facing port (DFP), or no role control.

13. The USB Type-C cable of claim 12, wherein the role control switch is further configured to couple a configuration channel (CC) pin of the DRP and a power cable of the USB Type-C plug using a first resistor.

14. The USB Type-C cable of claim 12, wherein the role control switch is further configured to couple a configuration channel (CC) pin of the DRP and a ground cable of the USB Type-C plug using a second resistor.

15. The USB Type-C cable of claim 12, wherein the role control switch is further configured to couple a configuration channel (CC) pin of the DRP and a CC wire of a cable on which the USB Type-C plug is disposed.

16. The USB Type-C cable of claim 13, wherein the role control switch comprises a mechanical dual in-line package switch.

17. The USB Type-C cable of claim 14, wherein the role control switch comprise a mechanical dual in-line package switch.

18. The USB Type-C cable of claim 15, wherein the role control switch comprise a mechanical dual in-line package switch,

19. The USB Type-C cable of claim 13, wherein the role control switch comprise an electrical switch.

20. The USB Type-C cable of claim 14, wherein the role control switch comprise an electrical switch.

21. The USB Type-C; cable of claim 15, wherein the role control switch comprise an electrical switch.

22. The USB Type-C cable of claim 12, wherein ports on both ends of the USB Type-C cable comprise USB Type-C plugs.

23. The USB Type-C cable of claim 12, wherein a port on one end of the USB Type-C cable comprises the USB Type-C plug, and a port on the other end comprising a USB Type-A plug.

24. The USB Type-C cable of claim 12, wherein a port on one end of the USB Type-C cable comprises the USB Type-C plug, and a port on the other end comprising a USB Type-B plug.

25. The USB Type-C cable of claim 12, wherein a port on one end of the USB Type-C cable comprises the USB Type-C plug, and a port on the other end comprising a USB Mini-B plug.

26. The USB Type-C; cable of claim 12, herein a port on one end of the USB Type-C cable comprises the USB Type-C plug, and a port on the other end comprising a USB Type-C plug that does not have a role control switch.

27. The USB Type-C cable according to claim 12, wherein a port on one end of the USB Type-C cable comprises the USB Type-C plug, and the other end being directly coupled to a device.
